(19) United States
(12) Patent Application Publication
(10) Pub. No.: US 2009/0210436 A1
(43) Pub. Date: Aug. 20, 2009

(54) ENCODING A HIERARCHICAL MULTI-LAYER DATA PACKAGE

(75) Inventor: Thomas M. Tirpak, Glenview, IL (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 11/929,623

(22) Filed: Oct. 30, 2007

(51) Int. Cl. G06F 17/30

(52) U.S. Cl. 707/101; 707/E17.044

(57) ABSTRACT

A hierarchical encoder is operable to create a hierarchical multi-layer data package. The hierarchical multi-layer data package includes a plurality of layers and one or more subpackages in each layer. The layers include one or more subpackages. A subpackage in an outer layer is related to a subpackage in an inner layer. Also, each subpackage includes meta data describing the encoding, a summary of a subset of data in the hierarchical multi-layer data and a link or ID of the subset of data in a compressed form.

### CROSS-REFERENCE TO RELATED APPLICATION

This patent application is related to U.S. patent application Ser. No. (TBD)(Attorney Docket No. CML06484BLUE), entitled “Decoding a Hierarchical Multi-Layer Data Package” by Tirpak, which is incorporated by reference in its entirety.

### BACKGROUND

Given current advances in network technology, high-bandwidth networks that allow large amounts of data to be transmitted to a destination are becoming more pervasive. These networks even include wireless networks or wireless access networks that allow transmission bursts of a large amount of data to a destination in a short period of time.

Given a high-bandwidth network, the problem is not so much how to quickly and efficiently transmit a large amount of data to a destination. Instead, situations may arise where a device receives a large amount of data in a short period of time, but due to the size of the data, the device cannot quickly and efficiently identify particular data of interest in the received data.

For example, in an emergency situation, emergency personnel receive a 200 GB data dump of medical records over a network for multiple injured people. If the receiving device is in the field, the device may not have the processing power or memory to quickly and efficiently identify vital information for an injured person from the 200 GBs of medical records. In another example, a real estate agent representing a buyer may download housing information meeting certain criteria for the buyer. However, because the information is organized from a seller's perspective, the real estate agent may miss certain listings or is unable to quickly identify information for the buyer. Thus, in these and other situations, due to the size and possibly the lack of organization of the transmitted data, the data are less usable to the receiving device and may, in some situations, be unusable, depending on the computing resources of the receiving device.

### BRIEF DESCRIPTION OF THE DRAWINGS

Embodiments are illustrated by way of example and not limited in the following Figure(s), in which like numerals indicate like elements, in which:

FIG. 1 illustrates a system, according to an embodiment;

FIG. 2 illustrates a hierarchical encoder, according to an embodiment;

FIG. 3 illustrates a hierarchical decoder, according to an embodiment;

FIG. 4 illustrates a hierarchical multi-layer data package, according to an embodiment;

FIGS. 5A-B illustrate a text document example of data to be coded, according to an embodiment;

FIGS. 6A-B and 7A-C illustrate an example of encoding the text document, according to an embodiment;

FIG. 8 illustrates a flow chart of a method for encoding data, according to an embodiment; and

FIG. 9 illustrates a computer system, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the description of the embodiments.

According to an embodiment, a hierarchical multi-layer data package is encoded. The hierarchical multi-layer data package, also referred to as data package, is comprised of a plurality of layers arranged in a hierarchy. Each layer includes one or more subpackages of data comprising summaries and meta data that allows a device to quickly identify information of interest in a layer, i.e., “skim” and determine whether to decode data in the layer or whether to “drill down” to a lower layer to identify data of interest. Thus, decoding the data package comprises evaluating summaries and metadata in subpackages in a layer and determining whether to drill down to related subpackages in lower layers or decompress information in a current layer.

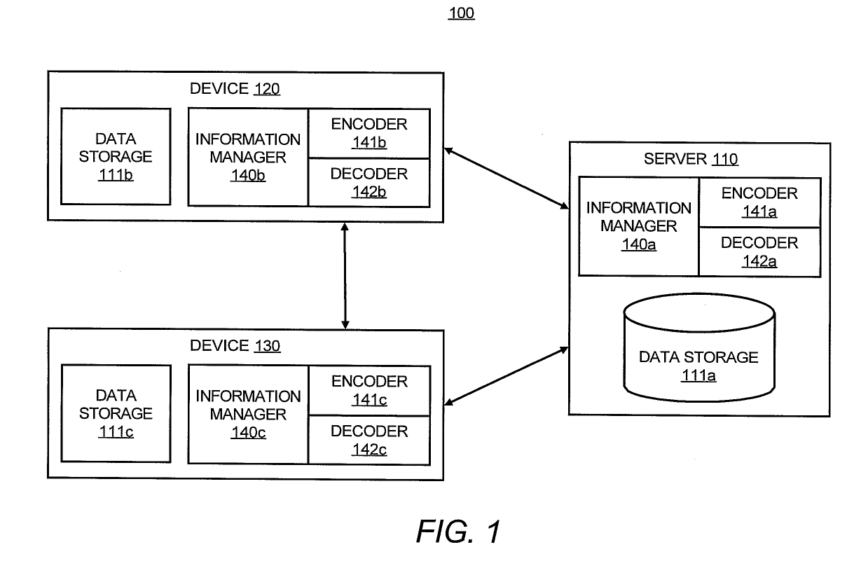

FIG. 1 illustrates a system 100 operable to code a hierarchical multi-layer data package. Coding includes encoding and decoding. FIG. 1 illustrates a server 110, a device 120 and a device 130. The server 110 and the devices 120 and 130 each include an information manager 140, an encoder 141, a decoder 142 and data storage 111, which are shown as 140a-c, 141a-c, 142a-c, and 111a-c, respectively.

The devices 120 and 130 may include devices that are operable to communicate with other devices via a network or via a peer-to-peer connection. For example, the devices 120 and 130 may communicate with the server 110 via a client-server arrangement over a network, and the devices 120 and 130 may communicate with each other using a peer-to-peer protocol. Examples of the devices 120 and 130 may include a personal digital assistant, laptop, desktop, set top box, a vehicle including a computer system or substantially any device or apparatus including a computer system operable to perform the functions of the embodiments described herein. Communication between the devices 120 and 130 and the server 110 may include wired and/or wireless connections.

FIG. 1 shows the server 110 and the devices 120 and 130 to illustrate that the coding embodiments may be employed in different types of devices and in different types of networks. It will be apparent to one of ordinary skill in the art that the coding embodiments may be provided in other types of systems. Furthermore, in one embodiment, an external data storage operating as a data repository may be used for storing data for the devices 120 and 130 or the server 140. In this embodiment, the data repository does not include an information manager or an encoder or decoder. The devices 120 and 130 may also store information locally.

The information manager 140 provides information to the encoder 141 to encode data for transmission to another device and also provides information to the decoder 142 to decode received data. For example, the information manager 140 maintains a list of topics of interest for the device. It also identifies the level of detail that is desired for each of these topics, e.g., “executive briefing”, 500 word summary, white paper, all available raw data, etc. The information manager 140 also maintains current information about the state of computing resources, e.g., the processor utilization, the free memory space, etc. Using this information, the information manager 140 makes coding decisions. For example, the information manager 140 provides the encoder 141 with a compression ratio that represents the best trade-off between data package size and ease of use. One embodiment generates such advice based not only on the current computing resource measurements for the device, but also on future resource usage predictions for the device and other devices in its network.

The information manager 140 determines the hierarchical compression strategy for encoding the data. This may includes the compression ratio, the maximum number of subpackages of data for a given layer in a data package and other metadata. The maximum number of subpackages may be a function of the number of statistically significant/different data clusters, as well as the status of available computing resources and the “operations goal” of the network of devices which share data packages. The “operations goal” may be based on the attributes of the computing resources for the anticipated set of devices which will transmit and/or use the data package. For example, portable devices with less memory and processing power may set goals that best utilize their computing resources. In general, more clusters will use more sub-packages, thereby increasing the specificity of the data in the sub-package.

The information manager 140 also determines the maximum and target number of layers in the data package. This is a function of the overall size of the data package, as well as the status of available computing resources and the “operations goal” of the network of devices which share data packages. In general, larger data packages may use more layers, thereby reducing the amount of data that needs to be scanned at the top layer. Higher compression rates and computational efficiencies can be obtained with larger data packages. Therefore, in on embodiment, the largest data sub-packages possible are used at each level in the hierarchy. This is consistent with the “burst” (transmission) and “skim” (search) approach.

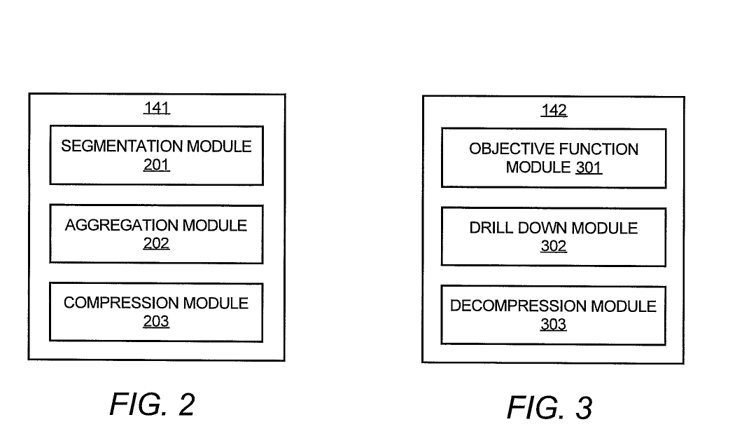

The encoder 141 is a hierarchical encoder. Modules in the encoder 141 are shown in FIG. 2. Modules include software performing certain functions. However, it will be apparent to one of ordinary skill in the art that the encoder 141 may be embodied in hardware, software or a combination of hardware and software.

The encoder 141, according to an embodiment, includes a segmentation module 201, an aggregation module 202 and a compression module 203. The segmentation module 201 applies a segmentation algorithm, which may be selected by the information manager 140, to data previously selected to be encoded. The segmentation module 201 generates clusters of data, and keywords and/or other identifiers are established for each cluster.

The aggregation module 202 applies an aggregation algorithm, which may be selected by the information manager 140, to the clusters to generate summaries for the clusters. Summaries may be provided in XML. The layer of the data package is updated to include the summaries.

The compression module 203 applies a hierarchal compression strategy determined by the information manager 140. The compression module 203 may apply a compression algorithm selected by the information manager 140. Also, the compression module 203 may apply an archiving method selected by the information manager 140. The archiving method employs the compression algorithm to compress data at different layers of the data package.

One example of an archiving method is a sequential method. In the sequential method raw source data is archived at layer 1; the subpackages at layer 1 are archived at layer 2; the subpackages at layer 2 are archived at layer 3; etc. If minimizing the data package size is important, a sequential compressed method may be applied that compresses the summaries at the current level and stores them in the archive section of the data package. Only the keywords and other meta data are provided in the data package as uncompressed. Another archiving method for minimizing the data package is the differential method. In the differential method differences between the raw source data and summaries at layer 1 are archived at layer 1, differences between summaries at layer 1 and summaries at layer 2 are archived at layer 2, differences between summaries at layer 1 and summaries at layer 2 are archived at layer 2, etc. The encoder 141 also records relevant compute-time statistics which can assist in the selection of summaries and real-time decoding of archives in the future.

The decoder 142 is a hierarchal decoder. According to an embodiment, the decoder 142 includes an objective function module 301, a drill-down module 302 and a decompression module 303, as shown in FIG. 3. The objective function module 301 uses an objective function to quantify the trade-offs associated with “goodness of fit” of the retrieved data, decompression time, and other applicable parameters of the data package, to guide the selection of a sequence of traversing the data package. The output of the objective function module 301, e.g., a score, may be used by the drill-down module 302 to determine whether to parse meta data and summaries for a lower layer in the hierarchy of the data package or use the data from a current a layer. The decompression module 303 decompresses the subpackage or subpackages of interest at the selected layer.

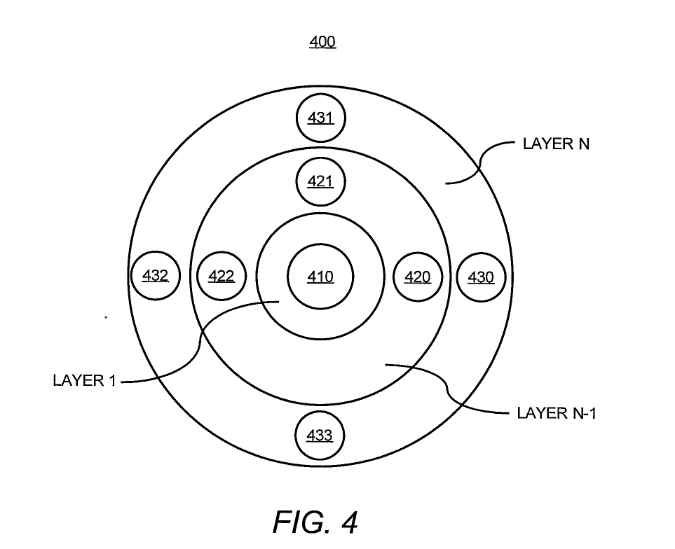

FIG. 4 illustrates a multi-layer hierarchical data package 400, according to an embodiment. The data package includes multiple layers shown as layers 1 through N. Each layer is comprised of one or more subpackages. For example, layer N has subpackages 430-433; layer N-1 has subpackages 420-422; and layer 1 has subpackage 410. The number of subpackages shown in each layer is provided by way of example and not limitation, and the number of subpackages in each layer may be different for different data packages.

When decoding, if the information manager 140 determines that the subpackage 430 is relevant but more information is needed, the decoder 142 drills down to a lower layer. For example, the subpackage 420 is related to the subpackage 430 and the meta data and summary for the subpackage 430 is parsed to determine whether that subpackage contains data of interest for the user. If so, the data is decompressed. Meta data for each subpackage may identify related subpackages in higher or lower levels in the hierarchy to allow for efficiently identifying a related subpackage in another layer for drill down.

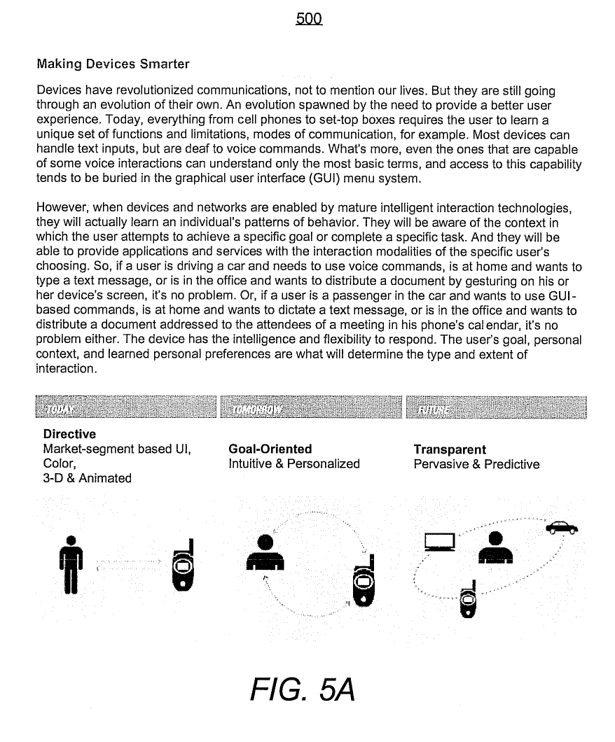

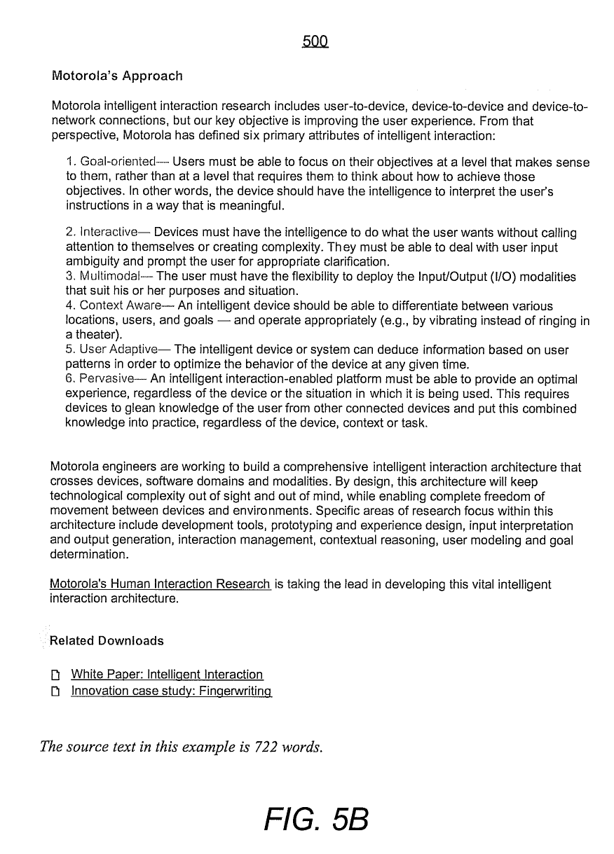

FIGS. 5A-B illustrates an example of data that may be encoded to form a multi-layer hierarchical data package. In this example, the data is a text document 500. However, it will be apparent to one of ordinary skill in the art that any type of data, e.g., video, audio, raw data, etc., may be encoded to form a multi-layer hierarchical data package as described in the embodiments herein.

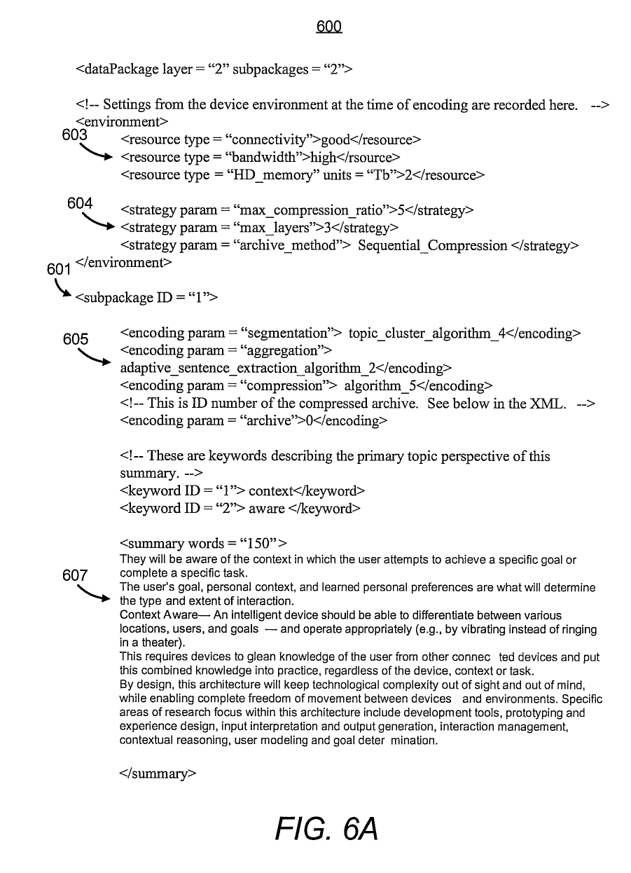

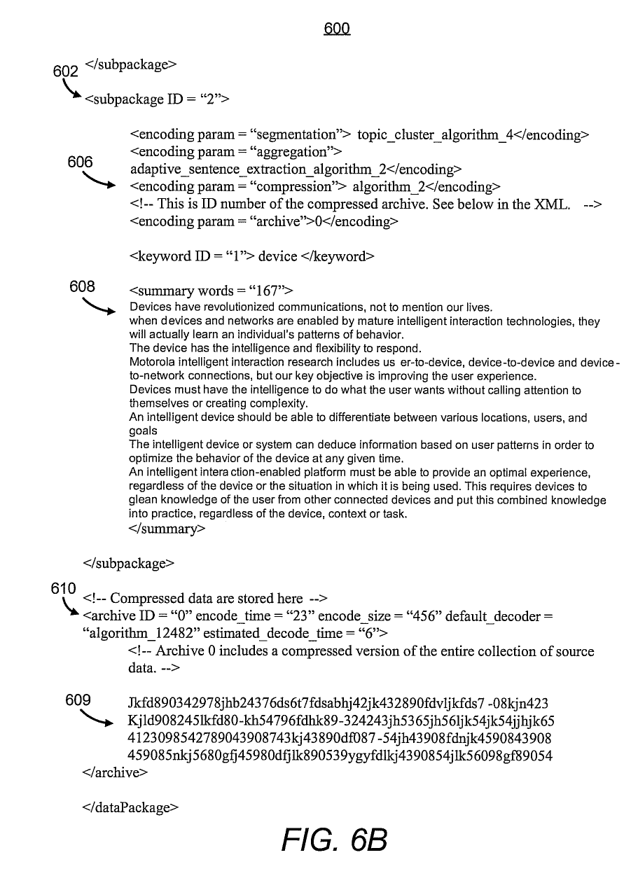

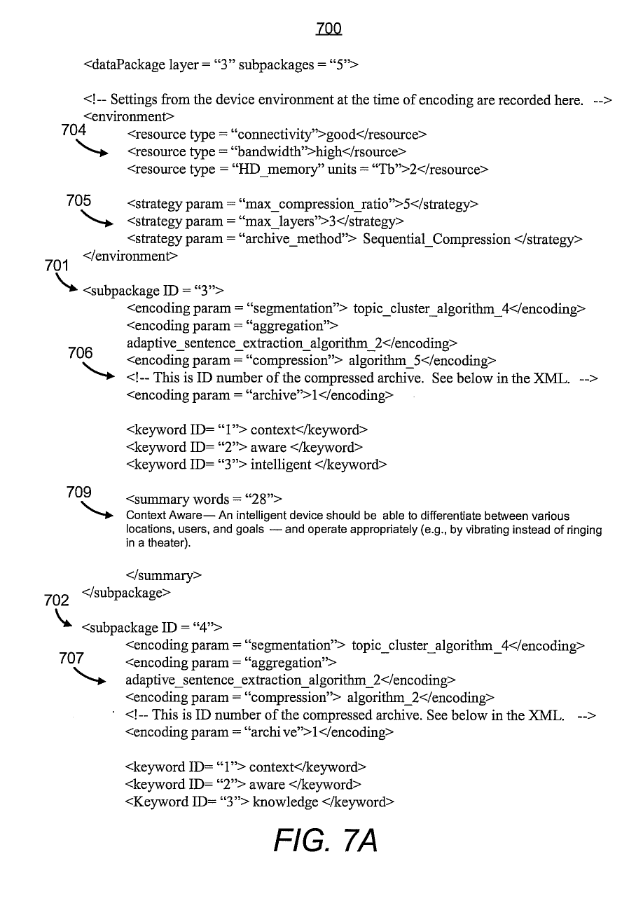

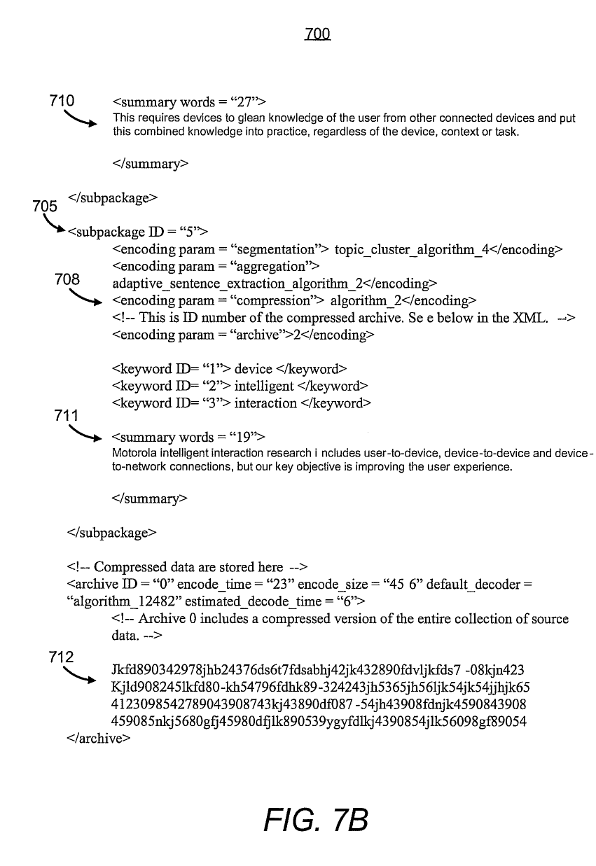

FIGS. 6A-B and 7A-C illustrate code representing at least some of the information in layers in a multi-layer hierarchical data package including 3 layers, according to an embodiment. FIGS. 6A-B and 7A-C illustrate the types of information and examples of information in the data package. It should be noted that data packages can have more or less layers with different numbers of subpackages and different information.

The data package shown in FIGS. 6A-B and 7A-C is comprised of data encoded from the text document 500 shown in FIGS. 5A-B. The data package includes 3 layers. Layer 3 is the outer most layer that would be parsed first by the decoder 142. Layer 3 represents a layer created from 3 cycles of compression. Layer 3 includes the most focused subpackages. Layer 2 is an intermediate layer. Layer 2 has fewer subpackages having more content and more general content. Layer 1 is not shown, but is the inner most layer of the data package and includes the most content and has the broadest scope, e.g., a representation of the original complete data.

In the data package shown in FIGS. 6A-B and 7A-C, the information manager 140 has established a target of 5 to 1 compression for each of the layers, and a maximum of 3 subpackages for each layer. FIGS. 6A-B show the intermediate layer 2 in the data package, which is labeled 600. There are 2 subpackages for layer 2 having subpackage IDs of 1 and 2 and shown as 601 and 602. Each layer also has meta data. Meta data for layer 2 is shown as 603 and 604. Meta data 603 may include attributes about the computing resources for the device, connectivity, bandwidth, etc. Meta data 603 provides information about the hierarchal compression strategy for the layer and data package. Meta data 603 may include the maximum compression ratio, the maximum number of subpackages per layer, the archival method, etc.

The subpackages also include meta data. Meta data 605 and 606 are shown for the subpackages 1 and 2 respectively, and includes information regarding the segmentation, aggregation and compression used. For example, segmentation includes the identification of sections of the overall data set that relate to specific themes or topic clusters. A number of algorithms may be used to perform such clustering. For a data example, segmentation can be accomplished by applying a data mining method, e.g., rule induction, classification based on association (CBA), etc. The meta data for segmentation may identify the clustering algorithm used to create the clusters.

Aggregation creates the summaries for the subpackages. In this example, the aggregation creates text summaries for the source document shown in FIGS. 5A-B6. The summaries correspond to the clusters, which may be topics of interest, identified in the segmentation. The meta data for aggregation may identify the aggregation method used to create the summaries, such as a sentence extraction method. For a data example not including text, aggregation may be accomplished by creating statistical summaries of data at a given level of stratification, i.e., including one or more segments of the data. Alternatively, data may be aggregated by generating explicit numerical relations that summarize a set of data, e.g., by using gene expression programming (GEP), such as described in U.S. Pat. No. 7,127,436, entitled “Gene Expression Programming Algorithm”, assigned to Motorola, Inc., which is incorporated by reference in its entirety. For raw data the summary may be a best fit equation or a collection of compressed views into data. For a time series, the summary may be a timeline trend that is sampled less frequently then the raw data or the summary only shows data when there is significant changes.

The meta data may also identify the compression algorithm for compressing the document. Compression algorithms generally apply to any set of binary data. However, the information manager 140 may select a compression algorithm that is specifically tuned for good performance with certain types of data, e.g., text-only, JPEG image set, etc.

The meta data also includes an ID or a link to the compressed data. For example, if the information manager 140 determines that the subpackage includes data of interest to the user, the link, shown as <encoding param=“archive”>0</encoding>, is used to find and retrieve the compressed data from the data package.

The meta data also includes one or more keywords describing the cluster, which is the topic of interest in this example. For example, the cluster for subpackage 1 is described by the keywords “context” and “aware”.

The subpackages 1 and 2 include summaries 607 and 608 respectively. The summaries are created through the aggregation process. The summaries help identify whether the data for the subpackage is sufficient for the user or whether to select another subpackage or drill down to another layer. Note that the summaries include text from the source document in FIGS. 5A-B that is related to the topic of interest, which represents the cluster described by the keyword(s) for the subpackage.

The compressed data for layer 2 is shown as 609 in FIG. 6B. Because the sequential archival method was used, layer 2 includes compressed data for lower-level layer 1. Meta data 610 for the compressed data may include information for coding the data. This information may be used by the information manager 140 to make coding decisions.

FIGS. 7A-C illustrate layer 3 in the data package. Layer 3 includes 3 subpackages, shown as subpackages 3-5 and labeled as 701-703. Layer 3 and the subpackages 305 include meta data similar to the meta data described above for layer 2. Layer 3 includes meta data 704 and 705. The subpackages 3-5 include meta data 706-708 and summaries 709-711. Note that the keywords for subpackages 3 and 4 include the keywords for subpackage 1. Also, each of the subpackages 3 and 4 includes an additional keyword. Thus, subpackages 3 and 4 are related to subpackage 1 in the hierarchy, but provide an additional level of detail as to the data in the data package. During decoding, if the information manager 140 determines subpackage 3 is relevant, the information manager 140 may decide to drill down to subpackage 1 if more information is needed. Similarly, subpackage 5 in layer 3 is related to subpackage 2 in layer 2. FIG. 7C shows as 710 and 711 the compressed data for each subpackage in layer 3 along with associated meta data.

Layer 3 also includes compressed data 712-714. Because the sequential archival method was used, layer 3 includes compressed data for lower-level layers 1 and 2. Other archival methods may store compressed data for the layer with the layer.

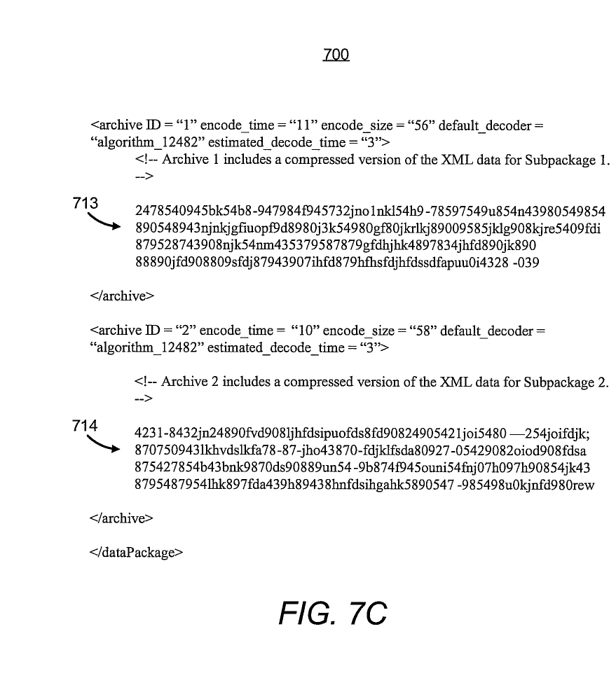

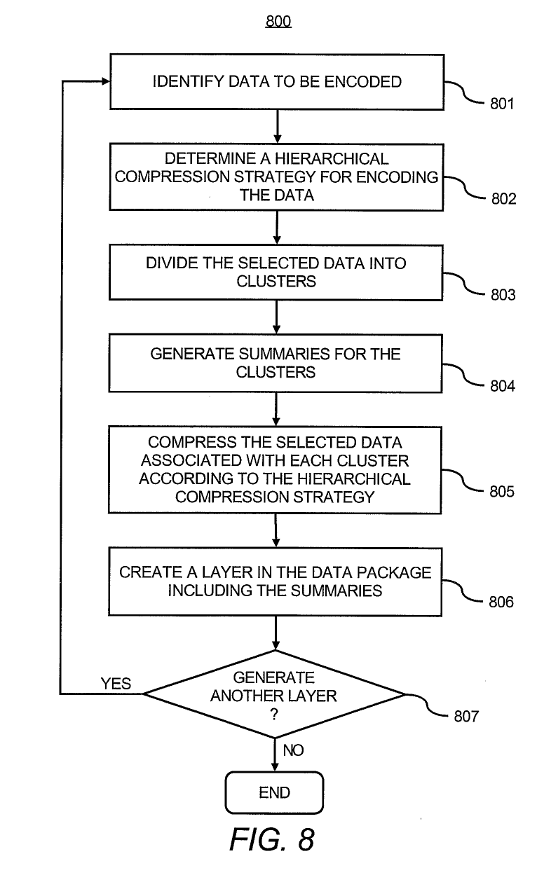

FIG. 8 illustrates a flow chart of a method 800 for encoding a multi-layer hierarchal data package, according to an embodiment. FIG. 8 is described with respect to one or more of FIGS. 1-7C by way of example and not limitation. It will be apparent to one of ordinary skill in the art that the method 800 may be practiced in other systems.

At step 801, data to be encoded is identified. For example, a set of files or some other set of data is selected for encoding. The data may be identified by a user or by other means.

At step 802, a hierarchal compression strategy is determined for encoding the data. The hierarchal compression strategy may include a target level of compression and preferred compression algorithms or archival methods based on intended recipients. For example, the compression strategy may be based on computing resource attributes for devices of intended recipients, negotiated policies and/or the number of topics or clusters.

At step 803, the selected data is divided into clusters. A segmentation algorithm may be used to generate the clusters.

At step 804, summaries are generated for the clusters, for example, using an aggregation algorithm. The summaries describe information in the clusters and may be used to identify information of interest to a user during decoding.

At step 805, the selected data associated with each cluster is compressed according to the hierarchical compression strategy. This may include implementing an archiving method, e.g., sequential, sequential compressed, differential, etc., to compress the data. Compression meta data may be generated and stored, such as compute time statistics that can be used for optimizing the decoding process in real-time.

At step 806, a layer in the data package is created including the summaries, meta data and compressed data. Examples of layers and the meta data are shown in FIGS. 6A-B and 7A-C, and each layer includes one or subpackages.

At step 807, a determination is made as to generate another layer. For example, the information manager 140 compares meta data for each subpackage to the hierarchal compression strategy selected by the information manager 140. If one or more of the desired compression rate, summary sizes, or keyword-based specificity of summaries, has been achieved, then the encoding is completed. If not, then steps 801-807 are repeated to create one or more other layers.

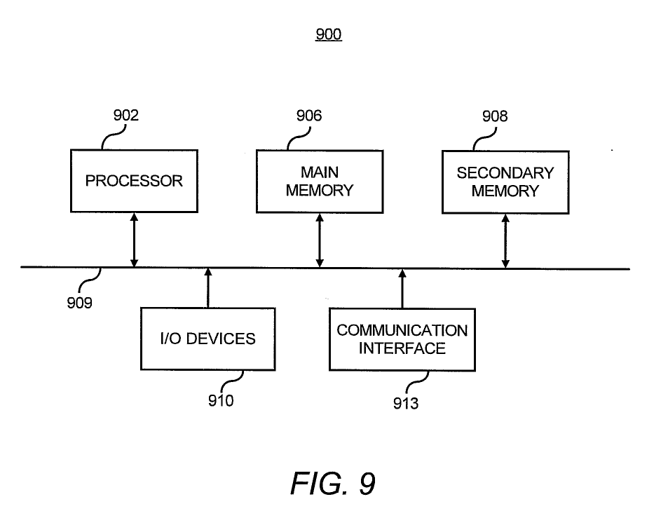

FIG. 9 illustrates a block diagram of a general purpose computer system 900 that is operable to be used as a platform for the components of the system 100 described above. For example, the system 900 may be representative of a platform for the server 110 or one or more of the user devices 120 and 130. Components may be added or removed from the general purpose system 900 to provide the desired functionality.

The system 900 includes a processor 902, providing an execution platform for executing software. Commands and data from the processor 902 are communicated over a communication bus 903. The system 900 also includes a main memory 906, such as a Random Access Memory (RAM), where software may reside during runtime, and a secondary memory 908. The secondary memory 908 may include, for example, a nonvolatile memory where a copy of software is stored. In one example, the secondary memory 908 also includes ROM (read only memory), EPROM (erasable, programmable ROM), EEPROM (electrically erasable, programmable ROM).

The system 900 includes I/O devices 910. The I/O devices may include a display and/or user interfaces comprising one or more I/O devices 910, such as a keyboard, a mouse, a stylus, speaker, and the like. A communication interface 913 is provided for communicating with other components. The communication interface 913 may be a wired or a wireless interface. The communication interface 913 may be a network interface. The components of the system 900 may communicate over a bus 909.

One or more of the steps of the methods described above and other steps described herein and software described herein may be implemented as software embedded or stored on a computer readable medium. The steps may be embodied by a computer program, which may exist in a variety of forms both active and inactive. For example, they may exist as software program(s) comprised of program instructions in source code, object code, executable code or other formats for performing some of the steps when executed. Modules include software, such as programs, subroutines, objects, etc. Any of the above may be stored on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated herein may be performed by any electronic device capable of executing the above-described functions.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A method of encoding a hierarchical multi-layer data package, the method comprising:
identifying data to be encoded;
selecting a hierarchal compression strategy to encode the data;
dividing the data into clusters;
generating summaries describing information in the clusters;
compressing the data using the selected hierarchal compression strategy;
forming a layer in the multi-layer data package including the summaries and the compressed data; and
forming at least one other layer in the hierarchal multi-layer data package by repeating the steps of selecting a hierarchal compression strategy to encode the data, dividing the data into clusters, generating summaries for the clusters, and compressing the data using the selected hierarchal compression strategy.

2. The method of claim 1, further comprising:
including meta data in each layer of the hierarchal multi-layer data package that is used to make decoding decisions for decoding one or more layers in the hierarchical multi-layer data package.

3. The method of claim 2, wherein the meta data describes the hierarchal compression strategy and information associated with the clusters.

4. The method of claim 2, further comprising:
determining statistics for compressing the data; and
including the statistics as the meta data in the hierarchal multi-layer data package.

5. The method of claim 2, wherein the meta data includes a link or an ID of compressed data in the hierarchal multi-layer data package associated with a summary also in the hierarchal multi-layer data package.

6. The method of claim 2, wherein forming at least one other layer in the hierarchal multi-layer data package comprises:
comparing the meta data for the layer with the selected hierarchal compression strategy; and
forming another layer if the hierarchal compression strategy is not achieved based on the comparison.

7. The method of claim 2, wherein the meta data comprises meta data for one or more subpackages in each layer of the hierarchical multi-layer data package and forming at least one other layer in the hierarchal multi-layer data package comprises:
comparing one or more of compression rate, summary size, or keyword-based specificity of summaries in the meta data for each subpackage to desired compression rate, desired summary size, or desired keyword-based specificity of the summary; and
forming the at least one other layer if one or more of the desired compression rate, desired summary size, or desired keyword-based specificity of the summary is not achieved.

8. The method of claim 1, wherein the layers in the hierarchal multi-layer data package form a hierarchy and a subpackage in an outer layer of the hierarchal multi-layer data package is related to a subpackage in an inner layer of the hierarchal multi-layer data package.

9. The method of claim 8, wherein the subpackage in the outer layer provides a provides a more detailed view of the compressed data in the hierarchal multi-layer data package than the subpackage in the inner layer.

10. The method of claim 1, wherein determining a hierarchal compression strategy comprises:
determining the attributes of a device using the hierarchal multi-layer data package; and
selecting the hierarchal compression strategy based on the attributes.

11. The method of claim 1, wherein determining a hierarchal compression strategy comprises:
negotiating between at least two devices to determine the hierarchical compression strategy.

12. The method of claim 1, wherein determining a hierarchal compression strategy comprises:
selecting the hierarchal compression strategy based on topics associated with the clusters.

13. The method of claim 1, wherein determining a hierarchal compression strategy comprises:
selecting a maximum compression ratio;
selecting a maximum number of layers; and
selecting an archiving method to compress the data.

14. The method of claim 13, wherein the archiving method comprises one of sequential, sequential compressed, and differential.

15. A device comprising:
a hierarchical encoder forming a hierarchical multi-layer data package including a plurality of layers and one or more subpackages in each layer, whereby a subpackage in an outer layer is related to a subpackage in an inner layer and each subpackage includes meta data describing the encoding, a summary of a subset of data in the hierarchical multi-layer data and a link or ID of the subset of data in a compressed form; and
an information manager providing information for determining a hierarchical compression strategy used to form the subpackages in the layers.

16. The device of claim 15, wherein for each layer the hierarchical encoder divides the data into clusters, generates the summaries which describe information in the clusters, and compresses the data using the hierarchal compression strategy.

17. The device of claim 15, wherein the hierarchical encoder forms another layer in the hierarchical multi-layer data package if one or more of a desired compression rate, desired summary size, or desired keyword-based specificity of summaries is not achieved for a subpackage.

18. The device of claim 15, wherein the meta data is used to make decoding decisions for decoding one or more layers in the hierarchical multi-layer data package.

19. A computer program embedded on a computer readable storage medium, the computer program including instructions that when executed by a processor implement a method of encoding a hierarchical multi-layer data package, the method comprising:
encoding a hierarchical multi-layer data package, the method comprising:
identifying data to be encoded;
selecting a hierarchal compression strategy to encode the data;
dividing the data into clusters;
generating summaries describing information in the clusters;
compressing the data using the selected hierarchal compression strategy;
forming a layer in the multi-layer data package including the summaries and the compressed data; and
forming at least one other layer in the hierarchal multi-layer data package by repeating the steps of selecting a hierarchal compression strategy to encode the data, dividing the data into clusters, generating summaries for the clusters, and compressing the data using the selected hierarchal compression strategy.

20. The computer program of claim 19, wherein the hierarchical multi-layer data package comprises:
a plurality of layers and one or more subpackages in each layer, whereby a subpackage in an outer layer is related to a subpackage in an inner layer and each subpackage includes meta data describing the encoding, a summary of a subset of data in the hierarchical multi-layer data and a link to or an ID of the subset of data in a compressed form.
